(19) United States
(12) Patent Application Publication
(10) Pub. No.: US 2014/0091600 A1
(43) Pub. Date: Apr. 3, 2014

(54) OVERSLAM BUMPER

(71) Applicants: Mark L. Lusky, Harrison Township, MI (US); Krzysztof P. Michalowski, Livonia, MI (US); Daniel James, Royal Oak, MI (US); Michael E. LaFleur, Brighton, MI (US)

(72) Inventors: Mark L. Lusky, Harrison Township, MI (US); Krzysztof P. Michalowski, Livonia, MI (US); Daniel James, Royal Oak, MI (US); Michael E. LaFleur, Brighton, MI (US)

(21) Appl. No.: 13/633,157

(22) Filed: Oct. 2, 2012

(51) Int. Cl. E05F 5/02

(52) U.S. Cl. 296/207

(57) ABSTRACT

An overslam bumper comprising a coupling device, a base member fixed to the coupling device, a striking member defining a striking surface for receiving a load exerted thereon, and a linking member connecting the base member and the striking member. The overslam bumper is configured such that upon receipt of the load at the striking surface, the load is transferred through the striking member to the linking member to an extent that the linking member will deflect, and upon deflection of the linking member, the striking member is operable to abut the base member.

### FIELD

The present disclosure relates to an overslam bumper used to dampen the closing of a door, hood, or tailgate of a vehicle.

### BACKGROUND

Overslam bumpers are known in the art for use as protective members that prevent a vehicle door, vehicle hood, or vehicle tailgate from unnecessarily contacting the vehicle body when the door, hood, or tailgate are slammed shut with too great a force. Due to manufacturing tolerances during production of a vehicle or the overslam bumper itself, the configuration of the overslam bumper can affect the amount of force required to completely close the door, hood, or tailgate. In this regard, customers appear to prefer doors, hoods and tailgates that close with low effort. If the material or design of the overslam bumper is not easily compressible, the amount of force can be increased.

### SUMMARY

The present disclosure provides an overslam bumper comprising a coupling device, a base member fixed to the coupling device, a striking member defining a striking surface for receiving a load exerted thereon, and a linking member connecting the base member and the striking member. The overslam bumper is configured such that upon receipt of the load at the striking surface, the load is transferred through the striking member to the linking member to an extent that the linking member will deflect, and upon deflection of the linking member, the striking member is operable to abut the base member.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of a vehicle door configured with an overslam bumper according to the present disclosure;

FIG. 2 is a side perspective view of the overslam bumper illustrated in FIG. 1;

FIG. 3 is a top perspective view of the overslam bumper illustrated in FIG. 1;

FIG. 4 is a cross-sectional view of the overslam bumper illustrated in FIG. 2;

FIG. 5 is a cross-sectional view of another overslam bumper according to a principle of the present disclosure;

FIG. 6 illustrates a load path through the overslam bumper upon application of a load;

FIG. 7 illustrates the overslam bumper during compression through application of a load;

FIG. 8 illustrates a load path through a prior art overslam bumper;

FIG. 9 is a graph illustrating load versus displacement for prior art overslam bumpers and overslam bumpers according to the present disclosure; and

FIGS. 10-13 illustrate various alternative configurations of an overslam bumper according to principles of the present disclosure.

### DETAILED DESCRIPTION

The present disclosure, therefore, provides an overslam bumper 10 that is easily compressible and does not require an overly compressible material than otherwise would be necessary.

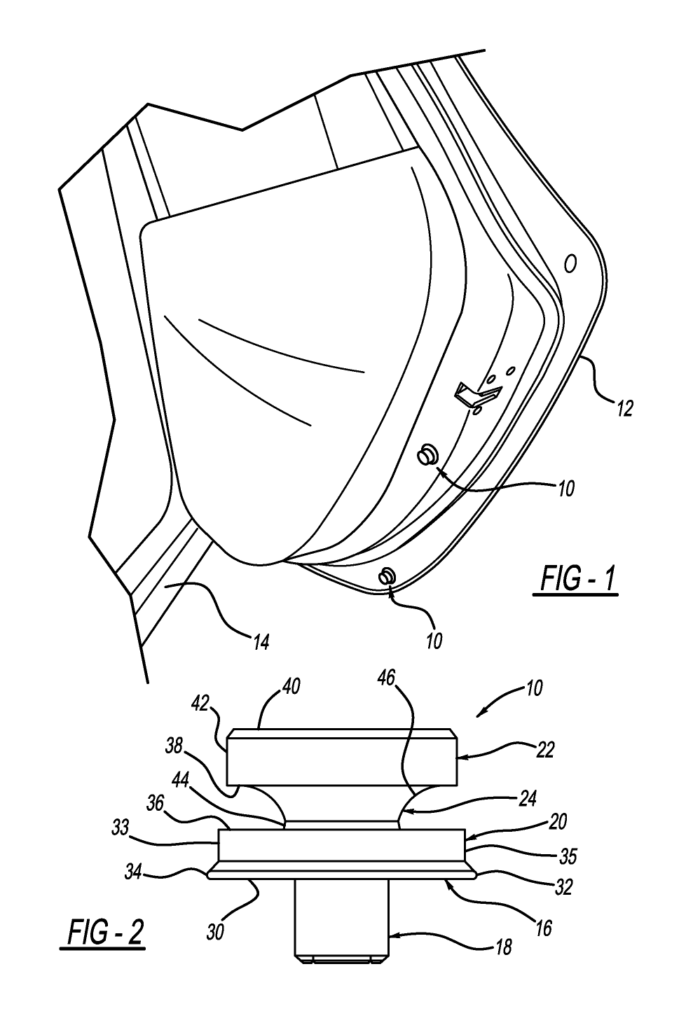

As illustrated in, for example, FIG. 1, an overslam bumper 10 according to the present disclosure can be disposed on the door 12 of a vehicle to prevent vehicle door 12 from slamming against the vehicle body 14 if too great a force is exerted on vehicle door 12 when closing vehicle door 12. Similarly, overslam bumpers 10 can be disposed on the vehicle body 14 to protect a hood (not shown) or tailgate (not shown) of the vehicle from slamming against vehicle body 14 of the vehicle when closed with too great of a force.

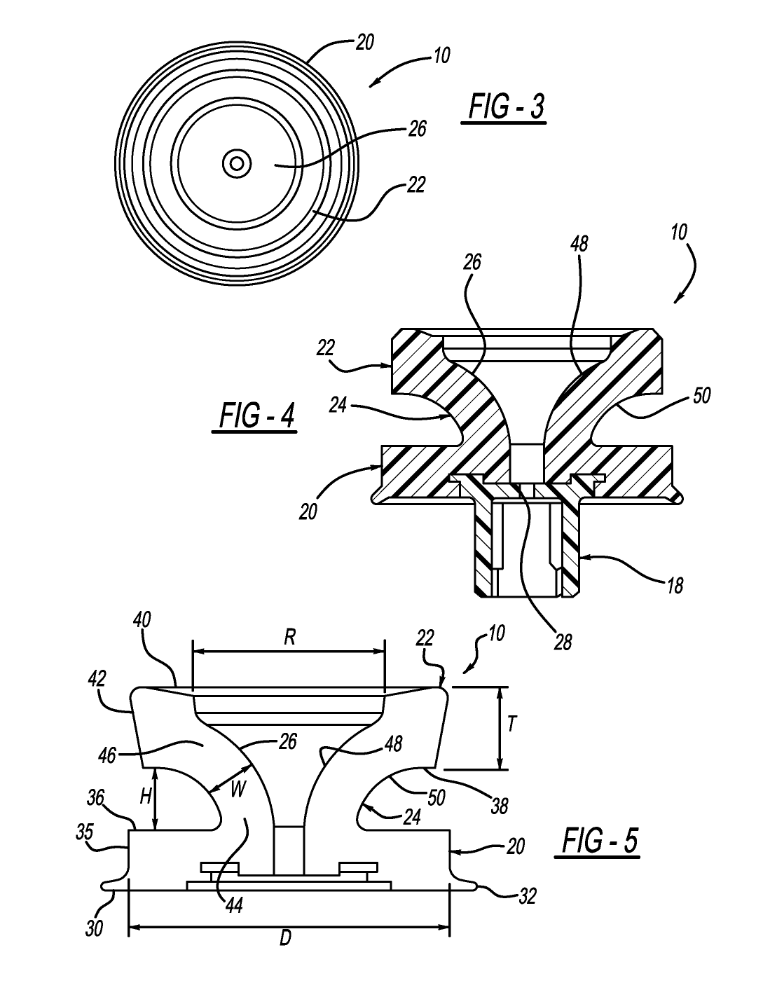

As best shown in FIGS. 2-7, overslam bumper 10 includes a resilient bumper member 16 that is attached to a coupling device 18. Bumper member 16 is operable to absorb force exerted thereon during closing of vehicle door 12, while coupling device 18 is operable to attach overslam bumper 10 to either vehicle door 12 or vehicle body 14. Although not shown in the figures, it should be understood that the coupling device should include various attachment features that ensure attachment of overslam bumper 10 to either vehicle door 12 or vehicle body 14.

Overslam bumper 10 is preferably molded over a portion of coupling device 18. In this regard, coupling device 18 may first be manufactured from a material such as glass-filled polypropylene, polyamide, aluminum, steel, or any other type of material that is satisfactorily rigid and able to rigidly attach overslam bumper 10 to vehicle body 14. Then, resilient bumper member 16 can be injection- or compression-molded over coupling device 18. Injection- or compression-molding resilient bumper member 16 over coupling device 18 is generally sufficient to satisfactorily adhere resilient bumper member 16 to coupling device 18. It should be understood, however, that an adhesive (not shown) can be disposed between resilient bumper member 16 and coupling device 18, without departing from the scope of the present disclosure. Resilient bumper member is preferably formed from materials such as natural rubber, ethylene-propylene-diene-monomer (EPDM), or any other polymeric material known to one skilled in the art.

Resilient bumper member 16 is preferably a unitary body that includes a first ring or base member 20 fixed to coupling device 18, a second ring or striking member 22 that is operable to contact either vehicle door 12 or vehicle body 14, and a neck or linking member 24 that is operable to deflect upon application of a sufficient force to striking member 22. Linking member 24 couples base member 22 to striking member 24.

Each of base member 20, striking member 22, and linking member 24 include an aperture 26 that narrows in the direction from striking member 22 to base member 20. Coupling device 18 may also include an aperture 28. The use of apertures 26 and 28 assists in preventing air or moisture from being trapped between overslam bumper 10 and either vehicle door 12 or vehicle body 14. If air or moisture were to become trapped between overslam bumper 10 and either door 12 or vehicle body 14, and overslam bumper 10 was not configured with apertures 26 and 28, a suction force that can increase the force required to open vehicle door 12 could arise.

Base member 20 and striking member 22 are each generally cylindrical in shape. Base member 20 includes a first lower surface 30 that is attached to coupling device 18. First lower surface 30 extends radially outward from coupling device 18, and may include a lip seal 32 at a terminal edge 34 thereof. Lip seal 32 assists in preventing dust and moisture from entering the interface between lower surface 30 and either vehicle door 12 or vehicle body 14. Opposite to first lower surface 30 is upper surface 36. An outer circumference 33 of base member 20 is defined by a wall 35 that connects first lower surface 30 and upper surface 36. Wall 35 may be arranged substantially orthogonally between first lower surface 30 and upper surface 36.

Similar to base member 20, striking member 22 includes a second lower surface 38 that is designed to abut upper surface 36 during operation of overslam bumper 10. Opposite second lower surface 38 is disposed a striking surface 40 that is operable to contact either vehicle door 12 or vehicle body 14. Sidewall 42 connecting second lower surface 38 and striking surface 40 may be arranged substantially orthogonally between second lower surface 38 and striking surface 40. As illustrated in FIG. 5, however, sidewall 42 may be arranged at an angle ranging between ten and twenty degrees relative normal.

Moreover, in lieu of having striking surface 40 being arranged parallel to first lower surface 30 of base member 20, striking surface 40 may be angled in a direction toward aperture 26 in a range of between ten and 20 degrees relative a plane that is parallel with first lower surface 30. By arranging striking surface 40 at an angle sloped in the direction of aperture 26, a surface area of striking surface 40 is reduced, which can reduce the surface area that contacts either door 12 or vehicle body 14. During repeated opening and closing of door 12, therefore, the contact between overslam bumper 10 and either door 12 or vehicle body 14 can be reduced, which can reduce a frictional wearing of the vehicle paint over time.

Linking member 24 connects base member 20 and striking member 22, and is operable to deflect in a manner that allows striking member 22 to contact base member 20 when a sufficient force is exerted on striking surface 40. In this regard, linking member 24 includes a first end 44 connected to base member 20 and a second end 46 connected to striking member 22. First end 44 is connected to base member 20 at a position located more radially inward than a position where second end 46 connects to striking member 22. By positioning first and second ends 44 and 46 in this manner, and by having an inner surface 48 (located directly adjacent aperture 26) and an outer surface 50 of linking member 24 each be rounded, linking member 24 is configured to deflect when a load is applied to striking surface 40.

As best shown in FIG. 5, distance H between base member 20 and striking member 22 can range between five and six millimeters. A diameter D of the base member 20 and the striking member 22 can range between ten and fifteen millimeters. A thickness T for each of base member 20 and striking member 22 can range between five and seven millimeters. A thickness W of linking member 24 can range between three and five millimeters. Lastly, a diameter R of aperture 26 can range between five and eight millimeters, with the diameter R of aperture 26 gradually tapering to less than this range as aperture 26 moves in a direction from striking surface 40 to first lower surface 30. One skilled in the art will readily acknowledge and appreciate, however, that each of the above-noted dimensions can be designed and tailored for any particular application. That is, when overslam bumper 10 is used on vehicle door 12, one skilled in the art would readily acknowledge and appreciate that the dimensions of overslam bumper 10 may be smaller in comparison to an overslam bumper 10 is used on, for example, a tailgate (not shown) or a vehicle hood (not shown).

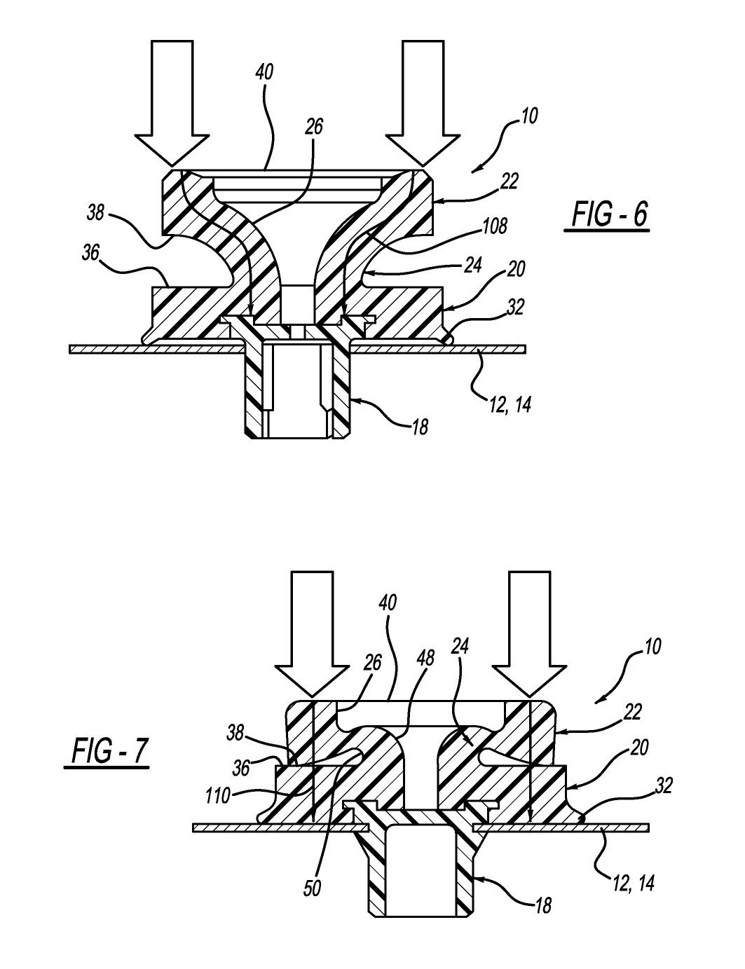

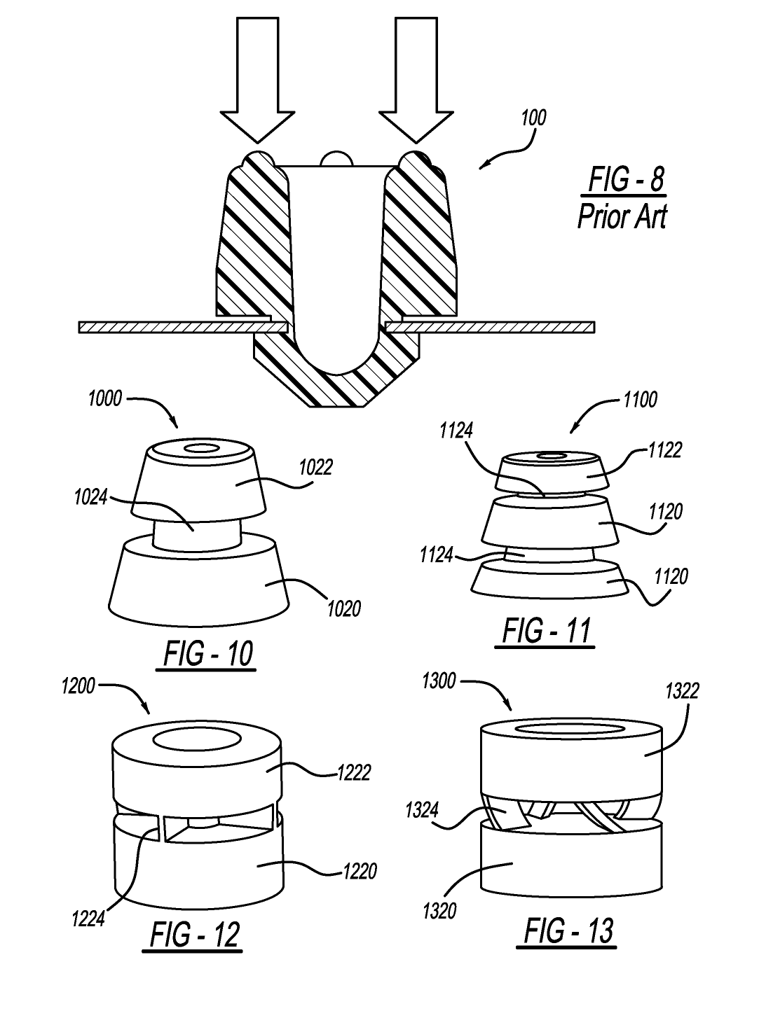

Now referring to FIGS. 6-9, operation of overslam bumper 10 will be described in more detail. Before describing the effect of overslam bumper 10, description of a conventional overslam bumper 100 will be described. As illustrated in FIG. 7, a conventional overslam bumper 100 is merely an annular piece of rubber that is substantially cylindrical in shape. Upon application of a load to the conventional overslam bumper 100, the conventional overslam bumper 100 will compress as far as the material that forms the conventional overslam bumper will allow. As noted above, however, due to manufacturing tolerances of vehicle door 12, vehicle body 14, components (not shown) that connect vehicle door 12 to vehicle body 14, and overslam bumper 100, a person may be required to exert more force than desired to shut vehicle door 12 (or hood or tailgate).

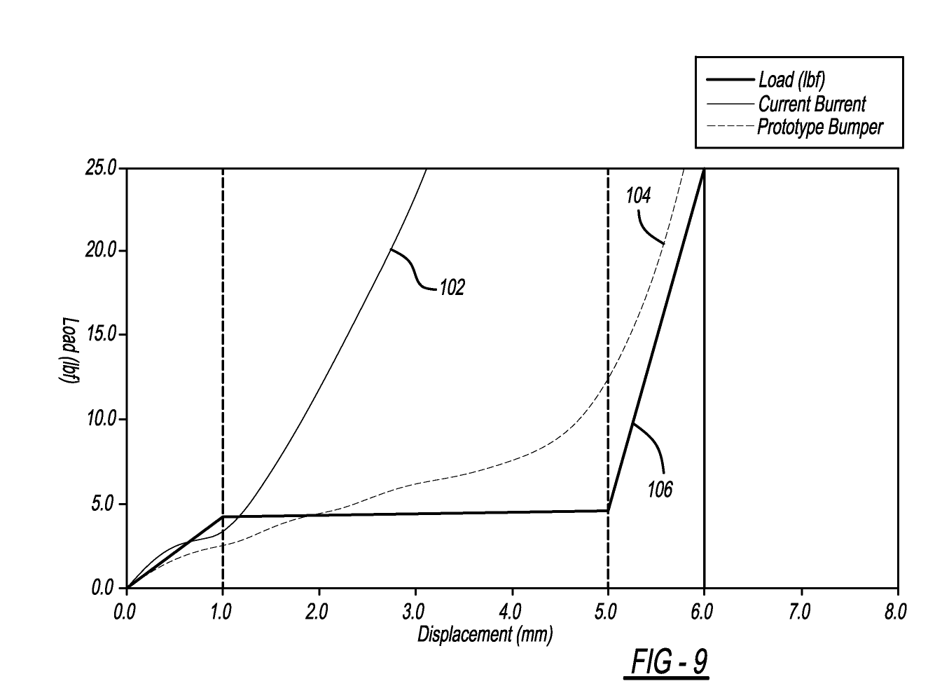

FIG. 9 is a graph depicting the amount of force required to compress conventional overslam bumper 100, overslam bumper 10 according to the present disclosure, and a theoretical optimal overslam bumper. According to FIG. 9, a curve 102 indicates that the load required to compress the conventional overslam bumper 100 increases sharply in comparison to a curve 104 that shows the load needed to compress overslam bumper 10 of the present disclosure. In this regard, curve 102 indicates that conventional overslam bumper 100 requires about twenty-five pounds of force to compress conventional overslam bumper 100 three millimeters, while curve 104 indicates that overslam bumper 10 of the present disclosure requires only about six pounds of force to compress overslam bumper 10 three millimeters. In fact, the force required to compress overslam bumper 10 according to the present disclosure only requires about twelve pounds of force to compress overslam bumper 10 five millimeters, which is generally the distance between base member 20 and striking member 22. Further, it can be seen that overslam bumper 10 compresses in a manner similar to the optimal compression of a theoretical optimal overslam bumper (curve 106).

Now referring to FIG. 6, it can be seen that the applied load applied to overslam bumper 10 does not travel in a completely linear manner through overslam bumper 10. Rather, the load 108 is transferred through striking member 22 in a substantially vertical direction until reaching linking member 24. Once load reaches linking member 24, the applied load travels radially inward toward aperture 26 until the load reaches nears base member 20. Once the load approaches base member 20, the load again begins to travel in a vertical direction.

When the applied load is translated in a radial direction through linking member 24, linking member 24 will deflect as shown in FIG. 7. As linking member 24 deflects, striking member 22 will begin to travel in a direction toward base member 20. Once linking member 24 has completely deflected such that striking member 22 contacts base member 20, the load 110 applied will travel through overslam bumper 10 in a completely linear direction (FIG. 7). Once striking member 22 has contacted base member 20, the force required to compress overslam bumper 10 increases similar to conventional overslam bumper 100 as indicated in FIG. 9. Regardless, due to overslam bumper 10 being able to compress in a manner where little force is needed to compress overslam bumper 10 over five millimeters, a person shutting door vehicle 12 is not required to exert too great a force due to unexpected build variations.

FIGS. 10-13 illustrate various alternative embodiments of an overslam bumper according to the present disclosure. FIG. 10 illustrates an overslam bumper 1000 having a base member 1020, a striking member 1022, and a linking member 1024. The primary difference between overslam bumper 1000 and overslam bumper 10 is that linking member 1024 is not rounded in a manner similar to linking member 24.

FIG. 11 illustrates an overslam bumper 1100 including a first ring 1120, a second ring 1122, and an intermediate ring 1126. Each ring 1120, 1122, and 1126 is coupled to each other through use of linking members 1124 that function similar to that of overslam bumper 10.

In FIG. 12, overslam bumper 1200 includes striking member 1222 and base member 1220. Linking member 24, however, is replaced by vanes 1224. Vanes 1224 are thinly formed membranes that deflect to allow striking member 1222 to contact base member 1220 in a manner similar to overslam bumper 10.

Lastly, FIG. 13 illustrates an overslam bumper 1300 having a striking member 1322, a base member 1320, and a plurality of linking loops 1324. Loops 1324 function in a manner similar to vanes 1224 in that loops 1324 are thinly formed membranes that allow deflection during application of a load to overslam bumper 1300.

What is claimed is:

1. A protective member, comprising:
a coupling device for attaching the protective member to one of a first member and a second member;
a resilient member fixed to said coupling device, said resilient member including a first ring, a second ring, and a deflectable linking member that couples said first ring and said second ring,
wherein upon application of a force to said first ring, said linking member deflects to an extent such that said first ring abuts said second ring.

2. The protective member of claim 1, wherein said first member is a vehicle door and said second member is a vehicle body.

3. The protective member of claim 1, wherein said first ring, said second ring, and said deflectable linking member each include an aperture.

4. The protective member of claim 1, wherein said first ring defines a striking surface.

5. The protective member of claim 1, wherein said deflectable linking member includes a first end attached to said first ring and a second end attached to said second ring, a position where said first end is attached to said first ring being located more radially outward than a position where said second end is attached to said second ring.

6. The protective member of claim 1, wherein said resilient member is formed of a compressible material.

7. The protective member of claim 1, wherein said first ring, said second ring, and said deflectable linking member are unitary.

8. The protective member of claim 1, wherein said second ring includes a lip seal at a terminal edge thereof.

9. An overslam bumper, comprising:
a coupling device;
a base member fixed to said coupling device;
a striking member defining a striking surface for receiving a load exerted thereon; and
a linking member connecting said base member and said striking member,
wherein upon receipt of said load at said striking surface, said load is transferred through said striking member to said linking member to an extent that said linking member will deflect, and
upon deflection of said linking member, said striking member is operable to abut said base member.

10. The overslam bumper of claim 9, wherein said base member, said striking member, and said linking member each include an aperture.

11. The overslam bumper of claim 9, wherein said linking member includes a first end attached to said striking member and a second end attached to said base member, a position where said first end is attached to said striking member being located more radially outward than a position where said second end is attached to said base member.

12. The overslam bumper of claim 9, wherein at least said striking member and said linking member are formed of a compressible material.

13. The overslam bumper of claim 9, wherein said base member, said striking member, and said linking member are unitary.

14. The overslam bumper of claim 9, wherein said base member includes a lip seal at a terminal edge thereof.

15. The overslam bumper of claim 9, wherein said base member and said striking member are each substantially cylindrically-shaped.

16. The overslam bumper of claim 15, wherein side walls of said striking member are angled relative a plane arranged orthogonal to said striking surface.

17. The overslam bumper of claim 15, wherein said striking surface is angled relative a plane arranged parallel to an upper surface of said base member.
